(19) United States
(12) Patent Application Publication
(10) Pub. No.: US 2024/0410969 A1
(43) Pub. Date: Dec. 12, 2024

(54) INFORMATION PROCESSING APPARATUS AND INFORMATION PROCESSING METHOD

(71) Applicants: Pixie Dust Technologies, Inc., Tokyo (JP); FrontAct Co., Ltd., Tokyo (JP)

(72) Inventors: Haruki NISHIMURA, Tokyo (JP); Megumi TABATA, Tokyo (JP); Akira ENDO, Tokyo (JP); Yasuhiro HABARA, Tokyo (JP); Masaki GOMI, Tokyo (JP); Yudai TAIRA, Tokyo (JP); Takashi HIRAOKA, Tokyo (JP); Kazuki TAKAZAWA, Tokyo (JP)

(73) Assignees: Pixie Dust Technologies, Inc., Tokyo (JP); FrontAct Co., Ltd., Tokyo (JP)

(21) Appl. No.: 18/808,209

(22) Filed: Aug. 19, 2024

Related U.S. Application Data
(63) Continuation of application No. PCT/JP2023/005887, filed on Feb. 20, 2023.

(30) Foreign Application Priority Data
Feb. 21, 2022 (JP) 2022-024504

(51) Int. Cl. G01S 3/801; G06T 11/20; G10L 15/22; H04R 1/32; H04R 3/00

(52) U.S. Cl. CPC G01S 3/801; G06T 11/206; G10L 15/22; H04R 1/326; H04R 3/005

(57) ABSTRACT

An information processing apparatus includes: acquiring information indicating a direction of a sound source with respect to at least one multi-microphone device; acquiring information regarding content of a speech emitted from the sound source and collected by the multi-microphone device; generating a map image in which the information regarding the content of the speech is arranged at a position corresponding to the direction of the sound source of the sound with respect to the multi-microphone device; and displaying the map image on a display unit of a display device.

### CROSS-REFERENCE TO RELATED APPLICATION

This application is a Continuation application of No. PCT/JP2023/5887, filed on Feb. 20, 2023, and the PCT application is based upon and claims the benefit of priority from Japanese Patent Application No. 2022-024504, filed on Feb. 21, 2022, the entire contents of which are incorporated herein by reference.

### FIELD

The present disclosure relates to an information processing apparatus, an information processing method, and a program.

### BACKGROUND

A person with hearing loss may have a reduced ability to perceive the direction of arrival of sound due to a reduced hearing function. When such a person with hearing loss tries to have a conversation among a plurality of persons, it is difficult to accurately recognize who is talking what, and a trouble occurs in communication.

Japanese Patent Application Laid-Open No. 2017-129873 discloses a conversation support apparatus that sets display regions corresponding to a plurality of users in an image display region of a display unit and displays a text which is a speech recognition result for a voice of a certain user in an image display region set for another user.

In the conversation support apparatus described in Japanese Patent Application Laid-Open No. 2017-129873, speeches of other users are displayed in an aggregated state in an image display region set for a certain user. Therefore, particularly when there are three or more participants in the conversation, it is difficult to immediately ascertain by whom each speech was made and what each person said.

### BRIEF DESCRIPTION OF THE DRAWINGS

FIG. 1 is a block diagram showing the configuration of an information processing system according to the present embodiment;

FIG. 2 is a block diagram showing a configuration of a controller of the present embodiment;

FIG. 3 is a view showing the appearance of the multi-microphone device of the present embodiment.

FIG. 4 is a view showing one aspect of the present embodiment.

FIG. 5 is a diagram showing data structure of a sound source database of the present embodiment;

FIG. 6 is a flowchart of a speech processing according to the present embodiment.

FIG. 7 is a diagram for explaining sound collection by a microphone;

FIG. 8 is a diagram for explaining the direction of a sound source in a reference coordinate system;

FIG. 9 is a diagram showing an example of a map image;

FIG. 10 is a flowchart of a sound source setting process according to the present embodiment.

FIG. 11 is a diagram showing an example of a screen displayed in the sound source setting process of the present embodiment.

FIG. 12 is a view showing an aspect of the Modification 1.

FIG. 13 is a diagram showing data structure of a speech database of the Modification 1;

FIG. 14 is a flowchart of a voice process according to the Modification 1;

FIG. 15 is a diagram showing an example of a map image of Modification 2;

FIG. 16 is a diagram showing another example of a map image of Modification 2;

FIG. 17 is a diagram showing an example of a map image of a Modification 3;

FIG. 18 is a diagram showing an example of image display of Modification 1;

### DETAILED DESCRIPTION

Hereinafter, an embodiment of the present invention will be described in detail with reference to the drawings. In the drawings for describing the embodiments, the same components are denoted by the same reference numerals in principle, and the repetitive description thereof will be omitted.

An information processing apparatus according to an aspect of the present disclosure includes: means for acquiring information indicating a direction of a sound source with respect to at least one multi-microphone device; means for acquiring information regarding content of a speech emitted from the sound source and collected by the multi-microphone device; means for generating a map image in which the information regarding the content of the speech is arranged at a position corresponding to the direction of the sound source of the speech with respect to the multi-microphone device; and means for displaying the map image on a display unit of a display device.

In the following description, coordinate system (microphone coordinate system) based on the position and orientation of the multi-microphone devices may be used. The microphone coordinate system has an origin at the position of the multi-microphone device (for example, the position of the center of gravity of the multi-microphone device), and the x-axis and the y-axis are orthogonal to each other at the origin. In the microphone coordinate system, when an x+ direction is defined as a front direction of the multi-microphone device, an x− direction is defined as a rear direction of the multi-microphone device, a y+ direction is defined as a left direction of the multi-microphone device, and a y− direction is defined as a right direction of the multi-microphone device. The direction of a specific coordinate system means a direction with respect to the origin of the coordinate system.

### (1) Configuration of Information Processing System

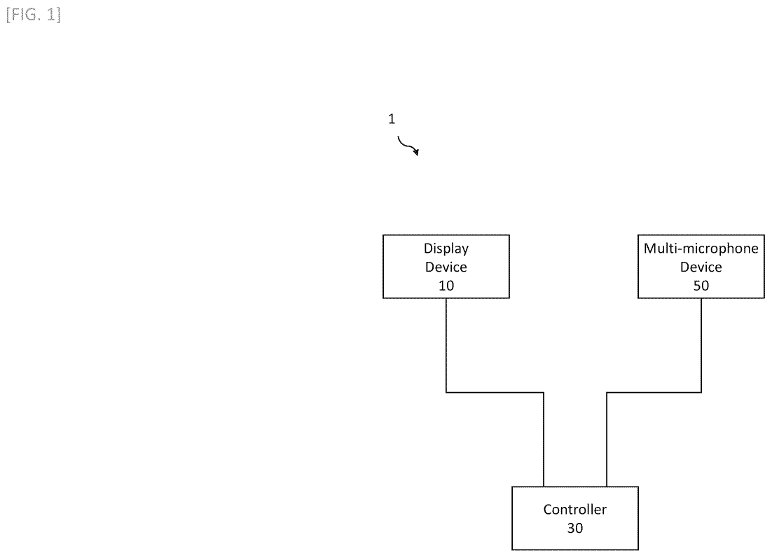

A configuration of the information processing system will be described. FIG. 1 is a block diagram showing the configuration of an information processing system according to the present embodiment.

As shown in FIG. 1, the information processing system 1 includes a display device 10, a controller 30, and a multi-microphone device 50.

The information processing system 1 is used by a plurality of users. At least one of the users may be a hearing-impaired person, or all of the users may not be hearing-impaired persons (i.e., all of the users may have sufficient hearing for conversation).

The display device 10 and the controller 30 are connected via a communication cable or a wireless channel (e.g., a Wi-Fi channel or a Bluetooth channel).

Similarly, the controller 30 and the multi-microphone device 50 are connected via a communication cable or a wireless channel (e.g., a Wi-Fi channel or a Bluetooth channel).

The display device 10 includes one or more displays 11 (an example of a “display unit”). The display device 10 receives an image signal from the controller 30 and displays an image corresponding to the image signal on the display. The display device 10 is, for example, a tablet computer, a personal computer, a smartphone, or a conference display apparatus. The display device 10 may include an input device or an operation unit for acquiring an instruction from a user.

The controller 30 controls the display device 10 and the multi-microphone device 50. The controller 30 is an example of an information processing apparatus. The controller 30 is, for example, a smartphone, a tablet computer, a personal computer, or a server computer.

The multi-microphone device 50 can be installed independently of the display device 10. That is, the position and orientation of the multi-microphone device 50 can be determined independently of the position and orientation of the display device 10.

### (1-1) Configuration of Controller

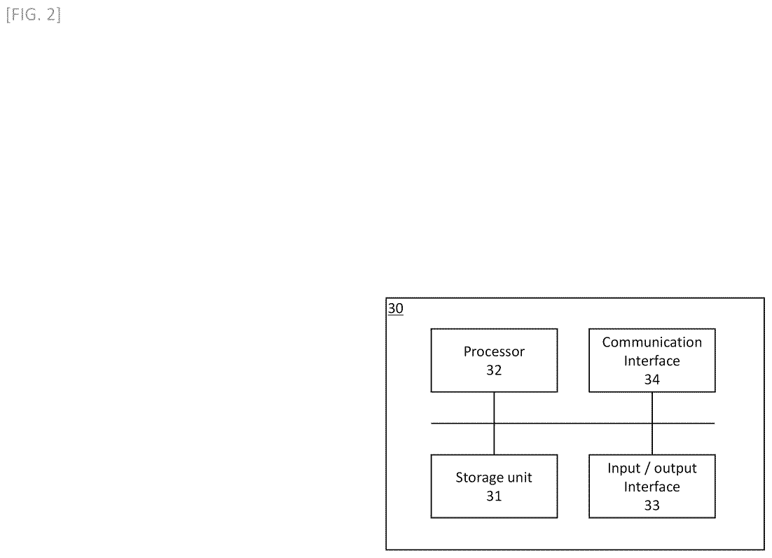

The configuration of the controller will be described. FIG. 2 is a block diagram showing the configuration of the controller of the present embodiment.

As shown in FIG. 2, the controller 30 includes a storage unit 31, a processor 32, an input/output interface 33, and a communication interface 34.

The storage unit 31 is configured to store programs and information. The storage unit 31 is, for example, a combination of a read only memory (ROM), a random access memory (RAM), and a storage (for example, a flash memory or a hard disk).

The program includes, for example, the following programs.
Program of OS (Operating System)
Program of application for executing information processing

The data includes, for example, the following data.
Database referred to in information processing
Data obtained by executing information processing (that is, execution result of information processing)

The processor 32 is a computer that implements the functions of the controller 30 by activating the program stored in the storage unit 31. The processor 32 is, for example, at least one of the following.
Central Processing Unit (CPU)
Graphic Processing Unit (GPU)
Application Specific Integrated Circuit (ASIC)
Field Programmable Gate Array (FPGA)

The input/output interface 33 is configured to acquire information (for example, an instruction of a user) from an input device connected to the controller 30 and output information (for example, an image signal) to an output device connected to the controller 30.

The input device is, for example, a keyboard, a pointing device, a touch panel, or a combination thereof.

The output device is, for example, a display.

The communication interface 34 is configured to control communication between the controller 30 and an external device (e.g., the display device 10 and the multi-microphone device 50).

### (1-2) Configuration of Multi-Microphone Device

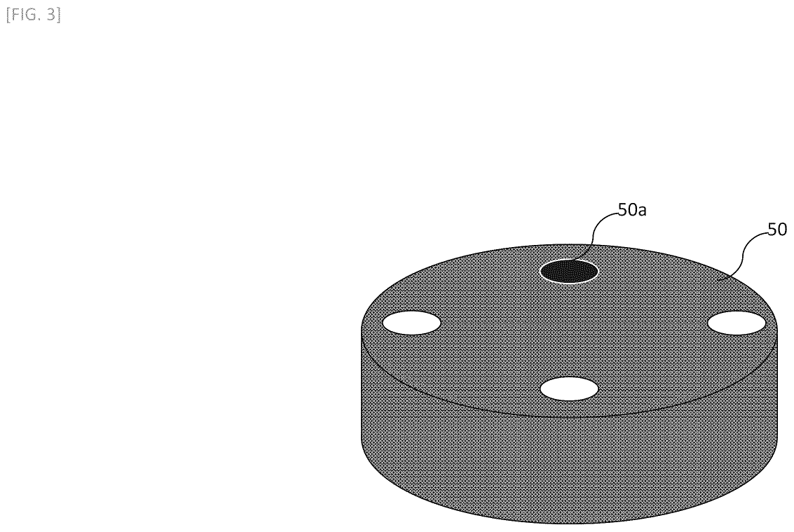

The configuration of the multi-microphone device will be described. FIG. 3 is a diagram showing an appearance of the multi-microphone device of the present embodiment.

The multi-microphone device 50 includes a plurality of microphones. In the following description, the multi-microphone device 50 includes five microphones 51-1, . . . , 51-5 (hereinafter, simply referred to as microphones 51 when not particularly distinguished). The multi-microphone device 50 generates a speech signal by receiving (collecting) sound emitted from a sound source using the microphones 51-1, . . . , 51-5. The multi-microphone device 50 estimates the arrival direction of sound (that is, the direction of the sound source) in the microphone coordinate system. The multi-microphone device 50 performs beamforming processing to be described later.

The microphone 51 collects, for example, sound around the multi-microphone device 50. The sound collected by the microphone 51 includes, for example, at least one of the following sounds.
Speech sound by a person
Sound of environment in which multi-microphone device 50 is used

The multi-microphone unit 50 is provided with a mark 50a indicating a reference direction of the multi-microphone unit 50 (for example, a forward direction (that is, x+ direction), but may be another predetermined direction) on the front face of the housing, for example. Thus, the user can easily recognize the direction of the multi-microphone device 50 from the visual information. Note that the means for recognizing the orientation of the multi-microphone device 50 is not limited to this. The mark 50a may be integrated with the housing of the multi-microphone device 50.

The multi-microphone device 50 further includes a processor, a storage unit, and a communication or input/output interface for performing, for example, speech processing, which will be described later. The multi-microphone device 50 may include an inertial measurement unit (IMU) for detecting the movement and state of the multi-microphone device 50.

### (2) One Aspect of Embodiment

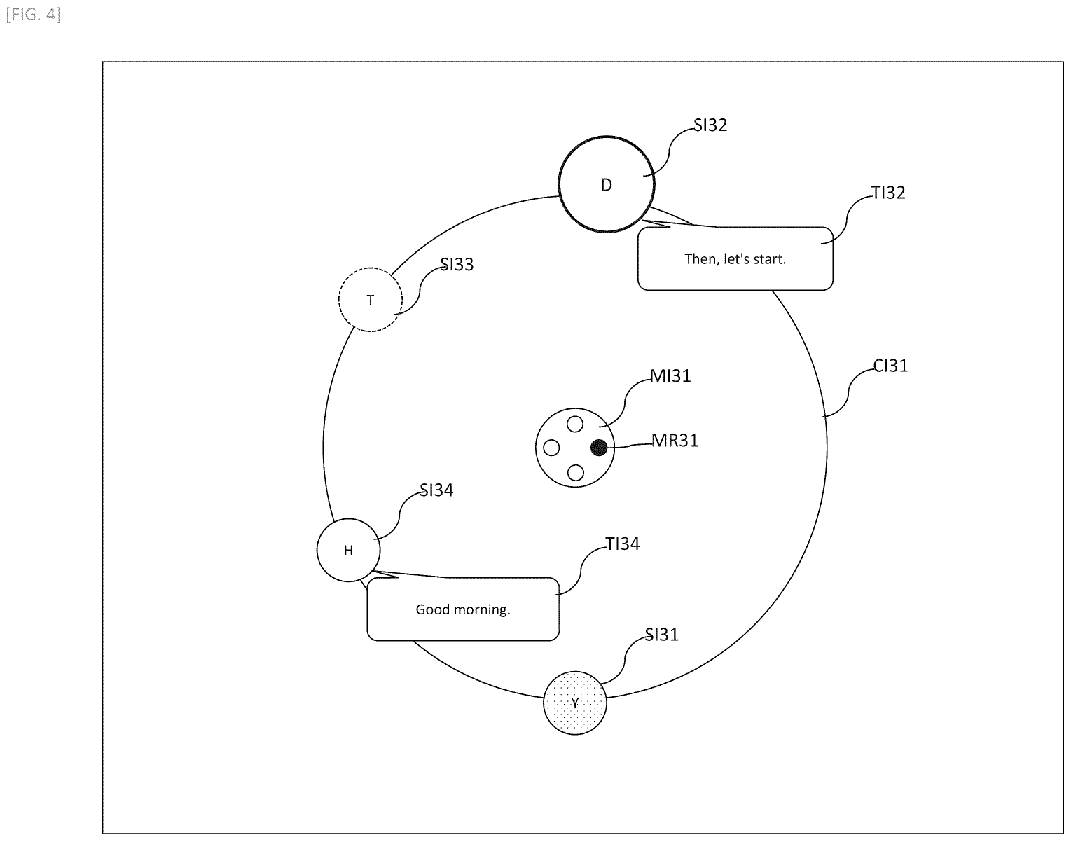

One aspect of the present embodiment will be described. FIG. 4 is a diagram showing one aspect of the present embodiment.

The controller 30 generates a map image and displays the map image on the display 11 of the display device 10 while a conversation (for example, a conference) is being held by a plurality of participants (that is, users of the information processing system 1). The map image corresponds to a view of a sound source (speaker) environment around the multi-microphone device 50, and a text (an example of “information regarding the content of a speech”) based on a voice uttered from the speaker is arranged at a position based on the direction of the speaker with respect to the multi-microphone device 50. The controller 30 updates the map image in accordance with the speech of the participant. Thus, the map image serves as a user interface (UI) for visually grasping the content of the latest conversation (particularly, who is talking what) in real time.

To be more specific, as shown in FIG. 4, the map image includes a microphone icon MI31, a circumference CI31, sound source icons SI31, SI32, SI33, SI34, and text images TI32 and TI34.

The microphone icon MI31 represents the multi-microphone device 50. The microphone icon MI31 includes a mark MI31 indicating the direction of the microphone icon MR31. The viewer of the map image can recognize where the microphone icon MR31 is directed in the map image by checking the mark MI31. By making the appearances of the microphone icons MI31 and the mark MR31 similar to the appearances of the multi-microphone devices 50 and the mark 50a, the viewer of the map image can easily associate the participants in the real world with the sound source icons in the map image. However, it is not essential to make the appearances of the microphone icons MI31 and the marks MR31 similar to the appearances of the multi-microphone devices 50 and the marks 50a.

The circumference CI31 corresponds to a circumference around the microphone icon MI31. In the example of FIG. 4, the controller 30 arranges sound source icons S131, S132, S133, and SI34 corresponding to the participants of the conversation on the circumferential CI31. To be more specific, the controller 30 arranges each of the sound source icons S131, S132, S133, and SI34 at a position on the circumference CI31 corresponding to the direction of the sound source represented by the sound source icon with respect to the multi-microphone device 50. As an example, the controller 30 converts the microphone coordinate system into coordinate system of a map image (hereinafter, referred to as “map coordinate system”). Then, the controller 30 arranges a sound source icon representing the sound source at an intersection of a straight line extending from the display position of the microphone icon MI31 (an example of “origin of map coordinate system”) in the (estimated) direction of the sound source represented by the map coordinate system and the circumference CI31.

The sound source icon SI31 represents a specific person (for example, a person who is hard of hearing and has more opportunities to see a map image than other participants. Hereinafter, the person may be referred to as “you”) among the plurality of participants. The controller 30 may set the sound source icon SI31 representing “you” to a specific format (e.g., colors, textures, optical effects, shapes, sizes, etc.) different from that of the sound source icons representing other sound sources, for example.

The sound source icon SI32 represents Mr. D among the plurality of participants. In the example of FIG. 4, Mr. D is speaking. The controller 30 may set a format different from that of the sound source icon representing the speaker (sound source) in another state to the sound source icon SI32 representing the speaker (sound source) who is making a speech. That is, the controller 30 can dynamically change the format of the sound source icon depending on the state of the sound source represented by the sound source icon.

The text image TI32 represents the latest message content of Mr. D (speech recognition result for the voice uttered by Mr. D). The controller 30 arranges the text image TI32 on the map image in a form in which the viewer of the map image can easily recognize that the text image SI32 and the sound source icon TI32 correspond to each other. As an example, the controller 30 arranges the text image TI32 at a predetermined position (for example, lower right) with respect to the sound source icon SI32. The controller 30 may set the text image TI32 to at least partially the same format as the sound source icon SI32. For example, the controller 30 may match the sound source icon SI32 and the background or characters of the text image TI32 to similar colors.

The sound source icon SI33 represents Mr. T among the plurality of participants. In the example of FIG. 4, Mr. T does not speak. The controller 30 may set a format different from that of the sound source icon representing the speaker (sound source) in another state to the sound source icon SI33 representing the speaker (sound source) who is not speaking.

The sound source icon SI34 represents Mr. H among the plurality of participants. In the example of FIG. 4, Mr. H has just finished speaking. The controller 30 may set a format different from that of the sound source icon representing the speaker (sound source) in another state to the sound source icon SI34 representing the speaker (sound source) immediately after the utterance is finished.

The text image TI34 represents the latest speech content of Mr. H. The controller 30 arranges the text image TI34 on the map image in a form in which the viewer of the map image can easily recognize that the text image SI34 and the sound source icon TI34 correspond to each other. As an example, the controller 30 arranges the text image TI34 at a predetermined position (for example, lower right) with respect to the sound source icon SI34. The controller 30 may set the text image TI34 to at least partially the same format as the sound source icon SI34. For example, the controller 30 may match the sound source icon SI34 and the background or characters of the text image TI34 to similar colors.

In this way, the controller 30 generates a map image by arranging the text corresponding to the voice uttered from the speaker at a position corresponding to the estimation result of the direction of the speaker with respect to the multi-microphone device 50, and displays the map image on the display 11 of the display device 10. Thus, the viewer of the map image can intuitively associate the speaker with the speech content.

### (3) Database

The database of the present embodiment will be described. The following database is stored in the storage unit 31.

### (3-1) Sound Source Database

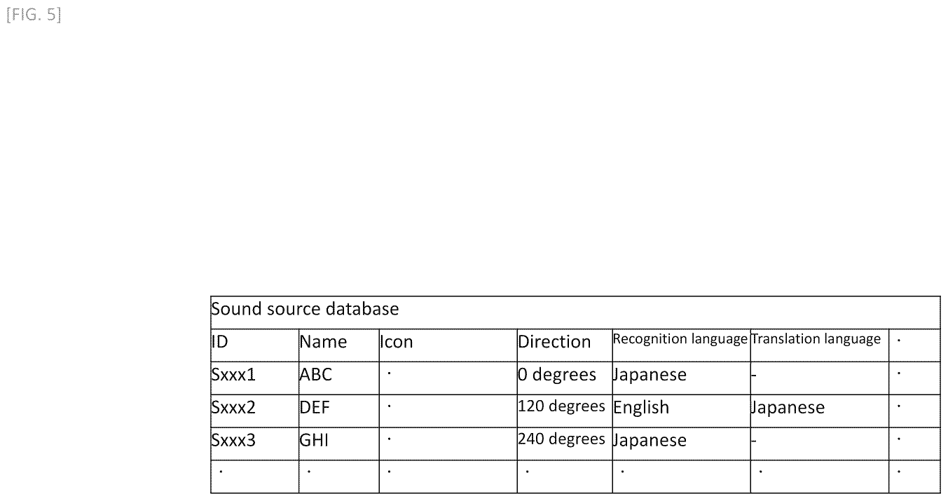

The sound source database of the present embodiment will be described. FIG. 5 is a diagram showing data structure of the sound source database of the present embodiment.

The sound source database stores sound source information. The sound source information is information on a sound source (typically, a speaker) around the multi-microphone device 50 identified by the controller 30.

As shown in FIG. 5, the sound source database includes an “ID” field, a “name” field, an “icon” field, a “direction” field, a “recognition language” field, and a “translation language” field. Each field is associated with each other.

The “ID” field stores a sound source ID. The sound source ID is information for identifying a sound source. When the controller 30 detects a new sound source, the controller 30 issues a new sound source ID and assigns the sound source ID to the sound source.

The “name” field stores sound source name information. The sound source name information is information on the name of the sound source. The controller 30 may automatically determine the sound source name information or may set the sound source name information in response to a user instruction as described later. The controller 30 may assign some initial sound source name to the newly detected sound source according to a predetermined rule or randomly.

The “icon” field stores icon information. The icon information is information related to an icon of a sound source. As an example, the icon information may include information that can identify an icon image (e.g., any of the preset icon images or a photograph or picture provided by the user) or the format of the icon (e.g., color, texture, optical effect, shape, etc.). The controller 30 may automatically determine the icon information or may set the icon information in accordance with a user instruction. The controller 30 may assign some initial icon to the newly detected sound source according to a predetermined rule or randomly.

However, in a case where the icon of the sound source is not displayed on the map image as in a Modification 2 described later, the icon information can be omitted from the sound source information.

The “direction” field stores sound source direction information. The sound source direction information is information regarding the direction of the sound source with respect to the multi-microphone device 50. As an example, the direction of the sound source is expressed as a deviation angle from a reference direction (in the present embodiment, the front direction (x+ direction) of the multi-microphone device 50) defined with reference to the microphones 51-1 to 51-5 in the microphone coordinate system.

The “recognition language” field stores recognition language information. The recognized language information is information about the language used by the sound source (speaker). Based on the recognition language information of the sound source, a speech recognition engine to be applied to the voice generated from the sound source is selected. The setting of the recognition language information may be designated by a user operation or may be automatically designated based on a language recognition result by a speech recognition model.

The “translation language” field stores translation language information. The translation language information is information on a target language in a case where a machine translation is applied to a speech recognition result (text) for a voice uttered from a sound source. A machine translation engine to be applied to a speech recognition result for a voice generated from a sound source is selected based on the translation language information of the sound source. The translation language information may be set for all sound sources at once instead of individual sound sources, or may be set for each display device 10.

In addition, the sound source information may include sound source distance information. The sound source distance information is information on the distance from the multi-microphone device 50 to the sound source. The sound source direction information and the sound source distance information can also be expressed as sound source position information. The sound source position information is information regarding a relative position of the sound source with respect to the multi-microphone device 50 (that is, coordinates of the sound source in a coordinate system of the multi-microphone device 50).

### (4) Information Processing

Information processing of the present embodiment will be described.

### (4-1) Speech Processing

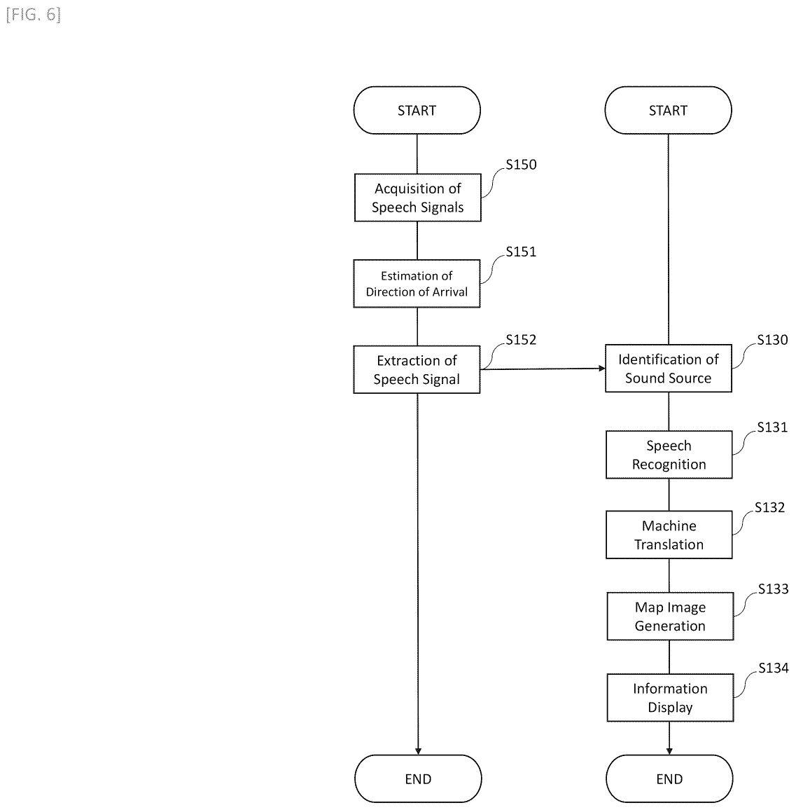

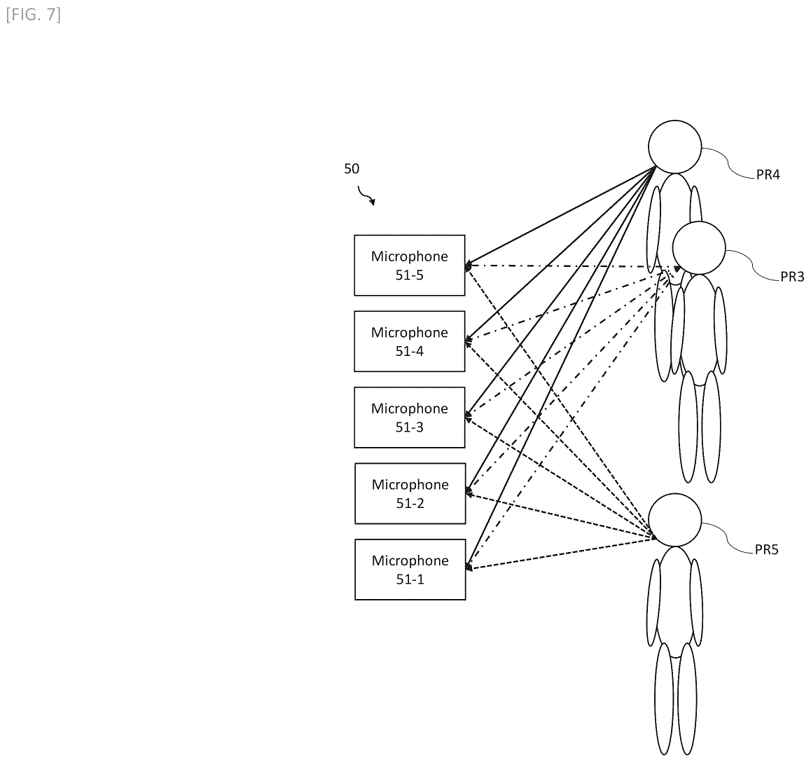

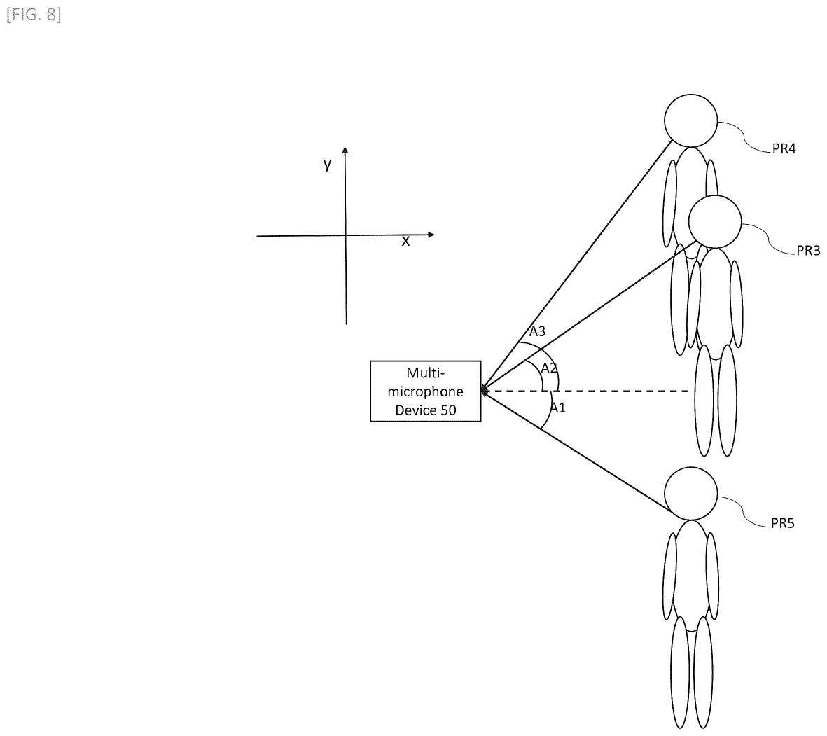

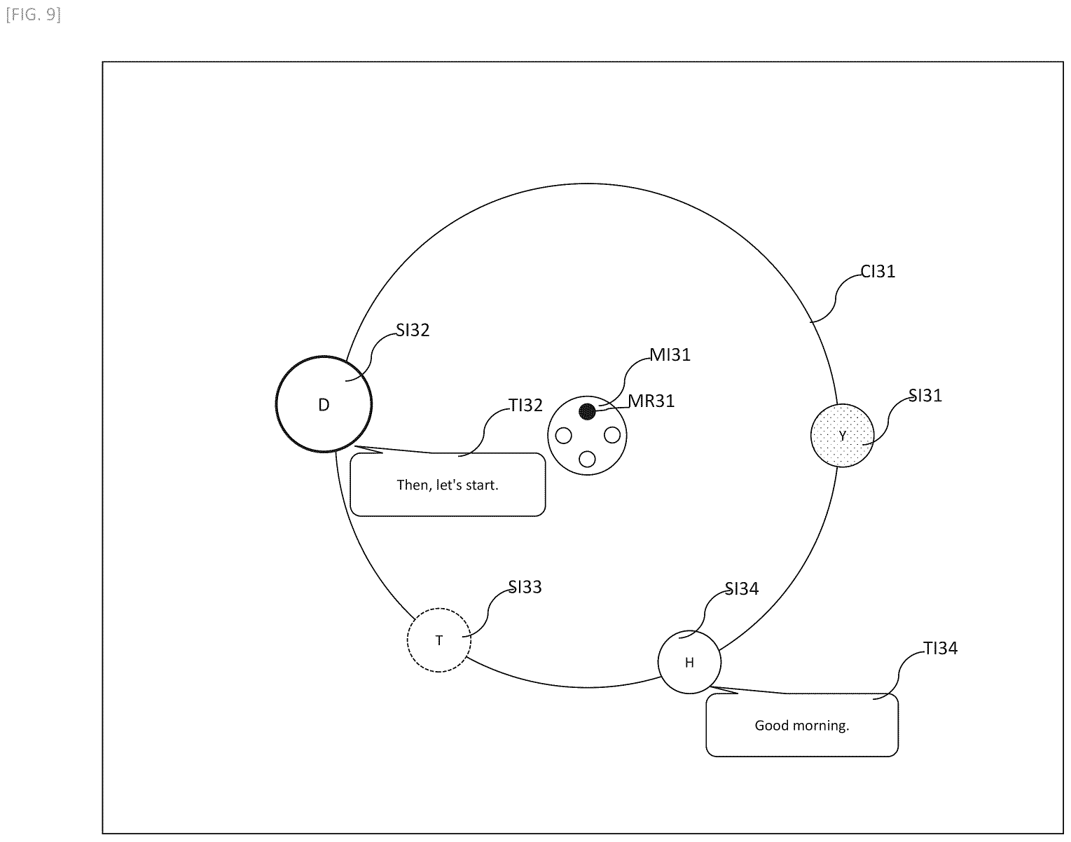

The speech processing of the present embodiment will be described. FIG. 6 is a flowchart of the speech processing according to the present embodiment. FIG. 7 is a diagram for explaining sound collection by a microphone. FIG. 8 is a diagram for explaining the direction of a sound source in the reference coordinate system. FIG. 9 is a diagram illustrating an example of a map image.

The speech processing shown in FIG. 6 is started after the display device 10, the controller 30, and the multi-microphone device 50 are powered on and the initial settings is completed. However, the start timing of the process illustrated in FIG. 6 is not limited thereto. The process shown in FIG. 6 may be repeatedly executed, for example, at a predetermined cycle, and thus the user of the information processing system 1 can view a map image updated in real time.

The multi-microphone device 50 acquires (S150) a speech signal via the microphones 51.

Specifically the plurality of microphones 51-1, . . . , 51-5 included in the multi-microphone device 50 collect the speech sound emitted from the speaker. The microphones 51-1 to 51-5 collect speech sounds that have arrived via a plurality of paths illustrated in FIG. 7. The microphones 51-1 to 51-5 convert collected speech sounds into speech signals.

The processor included in the multi-microphone unit 50 acquires, from the microphones 51-1 to 51-5, a speech signal including a speech sound uttered from at least one of the speakers PR3, PR4, and PR5. The speech signals acquired from the microphones 51-1 to 51-5 include spatial information (for example, delay and phase change) based on the path through which the speech sound has traveled.

After step S150, the multi-microphone device 50 executes estimation of the direction of arrival (S151).

The storage unit of the multi-microphone device 50 stores a direction-of-arrival estimation model. In the direction-of-arrival estimation model, information for specifying a correlation between spatial information included in the speech signal and the direction of arrival of the speech sound is described.

Any existing method may be used as the arrival direction estimation method used in the direction-of-arrival estimation model. For example, as the arrival direction estimation method, multiple signal classification (MUSIC) using eigenvalue expansion of an input correlation matrix, a minimum norm method, estimation of signal parameters via rotational invariance techniques (ESPRIT), or the like is used.

The multi-microphone device 50 estimates the arrival direction of the speech sound collected by the microphones 51-1 to 51-5 (that is, the direction of the sound source of the speech sound with respect to the multi-microphone device 50) by inputting the speech signals received from the microphones 51-1 to 51-5 to the direction-of-arrival estimation model. At this time, the multi-microphone device 50 expresses the arrival direction of the speech sound by a deviation angle from a reference direction (in the present embodiment, the front direction (x+ direction) of the multi-microphone device 50) defined with reference to the microphones 51-1 to 51-5 as 0 degrees in the microphone coordinate system, for example. In the example illustrated in FIG. 8, the multi-microphone device 50 estimates the arrival direction of the speech sound emitted from the speaker PR3 as a direction shifted from the x-axis to the left by an angle A2. The multi-microphone device 50 estimates the arrival direction of the speech sound emitted from the speaker PR4 as a direction shifted from the x-axis to the left by an angle A3. The multi-microphone device 50 estimates the arrival direction of the speech sound emitted from the speaker PR5 as a direction shifted from the x-axis to the right by an angle A1.

After step S151, the multi-microphone device 50 extracts (S152) the speech signal.

The storage unit included in the multi-microphone device 50 stores a beamforming model. The beamforming model describes information for specifying a correlation between a predetermined direction and a parameter for forming directivity having a beam in the direction. Here, forming directivity is a process of amplifying or attenuating sound in a specific arrival direction.

The multi-microphone device 50 calculates a parameter for forming directivity having a beam in the arrival direction by inputting the estimated arrival direction to the beamforming model.

In the example illustrated in FIG. 8, the multi-microphone device 50 inputs the calculated angle A1 to the beamforming model, and calculates a parameter for forming directivity having a beam in a direction shifted from the x-axis to the right by the angle A1. The multi-microphone device 50 inputs the calculated angle A2 to the beamforming model, and calculates a parameter for forming directivity having a beam in a direction shifted from the x-axis to the left by the angle A2. The multi-microphone device 50 inputs the calculated angle A3 to the beamforming model, and calculates a parameter for forming directivity having a beam in a direction shifted from the x-axis to the left by the angle A3.

The multi-microphone unit 50 amplifies or attenuates the speech signals acquired from the microphones 51-1 to 51-5 by the parameter calculated for the angle A1. The multi-microphone device 50 synthesizes the amplified or attenuated speech signals to extract a speech signal of the speech sound coming from the sound source in the direction corresponding to the angle A1 from the acquired speech signals.

The multi-microphone unit 50 amplifies or attenuates the speech signals acquired from the microphones 51-1 to 51-5 by the parameter calculated for the angle A2. The multi-microphone device 50 synthesizes the amplified or attenuated speech signals to extract a speech signal of the speech sound coming from the sound source in the direction corresponding to the angle A2 from the acquired speech signals.

The multi-microphone unit 50 amplifies or attenuates the speech signals acquired from the microphones 51-1 to 51-5 by the parameter calculated for the angle A3. The multi-microphone device 50 synthesizes the amplified or attenuated speech signals to extract a speech signal of the speech sound coming from the sound source in the direction corresponding to the angle A3 from the acquired speech signals.

The multi-microphone device 50 transmits the extracted speech signal to the controller 30 together with information indicating the direction of the sound source corresponding to the speech signal estimated in step S151 (that is, the estimation result of the direction of the sound source with respect to the multi-microphone device 50).

After step S152, the controller 30 executes identification of a sound source (S130).

Specifically the controller 30 identifies the sound source existing around the multi-microphone device 50 based on the estimation result of the direction of the sound source (hereinafter, referred to as a “target direction”) acquired in step 151.

As an example, the controller 30 determines whether or not the sound source corresponding to the target direction is the same as the identified sound source, and allocates a new sound source ID (FIG. 5) when the sound source corresponding to the target direction is not the identified sound source. Specifically the controller 30 compares the target direction with the sound source direction information (FIG. 5) for the identified sound source. Then, when it is determined that the target direction matches any of the sound source direction information for the identified sound sources, the controller 30 treats the sound source corresponding to the target direction as a (identified) sound source having the matched sound source direction information. On the other hand, when it is determined that the target direction does not match any of the sound source direction information for the identified sound sources, the controller 30 detects that a new sound source is present in the target direction, and assigns a new sound source ID to the new sound source. Here, the target direction matching the sound source direction information includes at least the target direction matching the direction indicated by the sound source direction information, and may further include the difference or ratio of the target direction to the direction indicated by the sound source direction information being within an allowable range.

After step S130, the controller 30 executes the speech recognition process (S131).

The storage unit 31 stores a speech recognition model. In the speech recognition model, information for specifying correlations between the speech signals and the texts corresponding to the speech signals is described. The speech recognition model is, for example, a learned model generated by machine learning. The speech recognition model may be stored in an external device (for example, a cloud server) accessible by the controller 30 via a network (for example, the Internet), instead of the storage unit 31.

The controller 30 inputs the extracted speech signal to the speech recognition model to determine a text corresponding to the input speech signal. The controller 30 may select the speech recognition engine based on the recognition language information of the sound source corresponding to the speech signal.

In the example illustrated in FIG. 8, the controller 30 inputs the speech signals extracted for the angles A1 to A3 to the speech recognition model, and thereby determines the text corresponding to the input speech signals.

After step S131, the controller 30 executes machine translation (S132).

To be specific, when the translation language information (FIG. 5) is set in the sound source of the speech corresponding to the text generated in step S131, the controller 30 performs machine translation of the text. Thus, the controller 30 obtains text in the language designated by the translation language information. The controller 30 may select the machine translation engine based on the translation language information of the sound source corresponding to the speech signal. On the other hand, the controller 30 can omit this step when the translation language information (FIG. 5) is not set in the sound source of the speech corresponding to the text generated in step S131 (that is, when the speech is converted into text without being translated).

After step S132, the controller 30 executes generation of a map image (S133).

To be specific, the controller 30 generates a text image representing a text based on the result of the speech recognition process in step S131 or a text based on the result of the machine translation process in step S132. The controller 30 arranges the sound source icon representing the identified sound source around the microphone icon (for example, on a circumference around the microphone icon) based on the direction of the sound source with respect to the multi-microphone device 50 (that is, the estimation result of step S151). The controller 30 arranges the text image at a predetermined position with respect to a sound source icon representing a sound source of a corresponding sound.

As an example, the controller 30 generates a map image shown in FIG. 9. In the map image of FIG. 9, the microphone coordinate system is converted into the map coordinate system such that the front (x+ direction) of the microphone icon MI31 faces the upper direction of the map image. However, the controller 30 can change the correspondence relationship between the microphone coordinate system and the map coordinate system. As an example, the controller 30 may rotate the display position of each sound source icon around the display position of the microphone icon MI31 so that a specific sound source icon is positioned in a predetermined direction (for example, downward direction) of the map coordinate system in response to the user instruction. For example, the map image of FIG. 4 can be generated by rotating the display positions of the sound source icons SI31 to SI34 counterclockwise by 90° around the display position of the microphone icon MI31 in the map image of FIG. 9 so that the sound source icon SI31 is positioned in the lower direction of the map image, and moving the text images TI32 and TI34 to predetermined positions (for example, “lower right”) with respect to the rotated sound source icons S132 and S134.

Further, the controller 30 may generate the map image so as to emphasize the sound source icon representing the sound source or the text related to the sound while the sound source is emitting the sound. The controller 30 may highlight the sound source icon or text by, for example, at least one of the following:
addition of animation;
enlarged display; and
change in color, texture, optical effect or shape.

After step S133, the controller 30 executes information display (S134).

To be more specific, the controller 30 displays the map image generated in step S133 on the display 11 of the display device 10.

### (4-2) Sound Source Setting Process

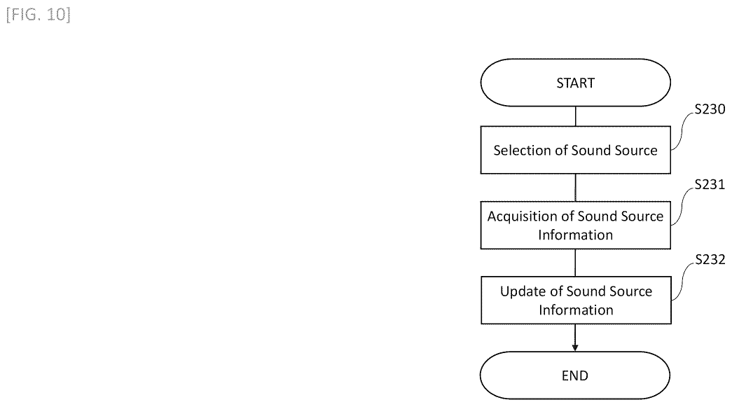

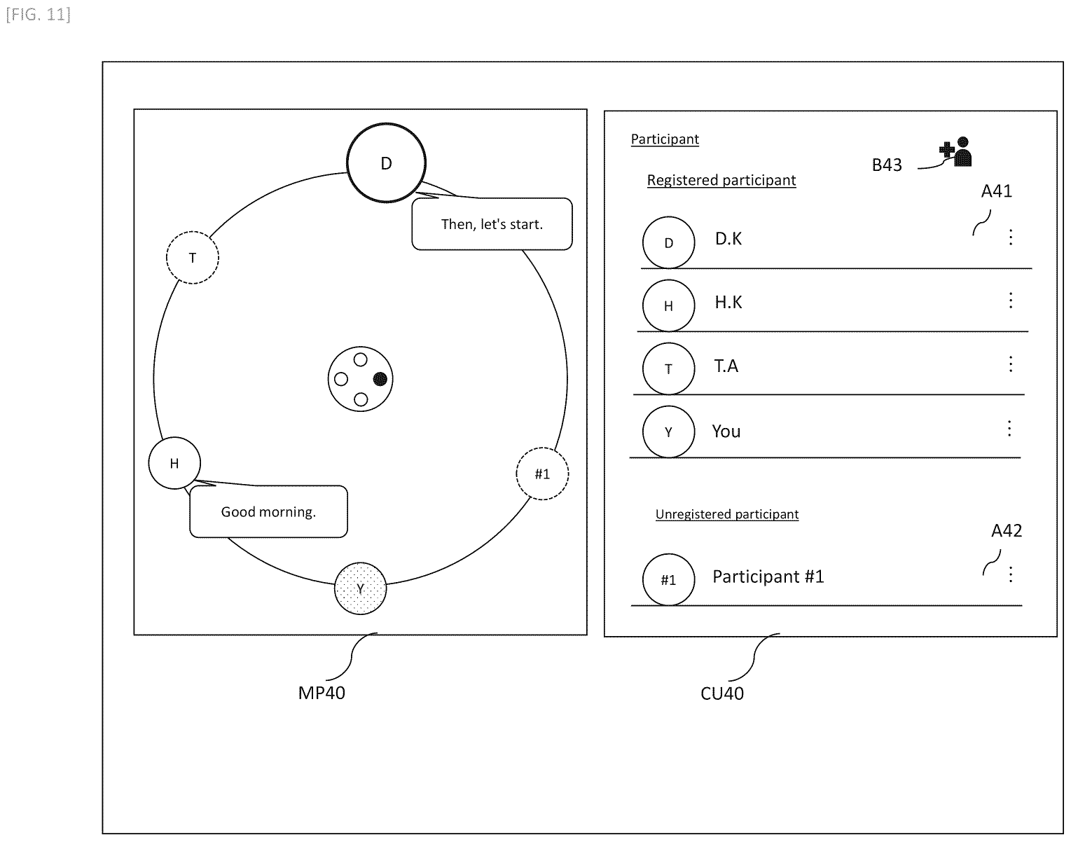

The sound source setting process of the present embodiment will be described. FIG. 10 is a flowchart of the sound source setting process of the present embodiment. FIG. 11 is a diagram showing an example of a screen displayed in the sound source setting process of the present embodiment.

The sound source setting process shown in FIG. 10 is started in response to an instruction from the user of the information processing system 1 after the start of the sound process shown in FIG. 6. However, the start timing of the sound source setting process shown in FIG. 10 is not limited to this. For example, the process of FIG. 10 may be executed as an initial setting process before the start of the speech process shown in FIG. 6.

As shown in FIG. 10, the controller 30 executes selection (S230) of a sound source.

Specifically, the controller 30 displays a sound source setting UI for the user to set sound source information on the display 11 of the display device 10. As an example, the controller 30 displays a screen of FIG. 11 on the display 11 of the display device 10. The screen of FIG. 11 includes a map image MP40 and a sound source setting UI (image) CU40.

The sound source setting UI CU40 includes display objects A41 and A42 and an operation object B43.

The display object A41 displays information of the registered participant (for example, a sound source icon and a registered sound source name). Here, the registered participant means a sound source whose sound source name information is registered by the sound source setting process shown in FIG. 10, among the sound sources (speakers) identified in the sound source identification (S130) of FIG. 6.

The display object A42 displays information (for example, a sound source icon and an initial sound source name) of an unregistered participant. Here, the unregistered participant means a sound source (that is, a sound source using the initial sound source name determined by the controller 30) of which the sound source name information is not registered among the sound sources (speakers) identified in the identification (S130) of the sound source of FIG. 6.

The operation object B43 receives an operation of adding a participant. To be specific, the user of the information process system 1 selects the operation object B43 and further designates any of the unregistered participants. The controller 30 may present an input form (e.g., a text field, a menu, a radio button, a checkbox, or a combination thereof) on the display device 10 to accept the designation of the unregistered participant.

The controller 30 selects a sound source (unregistered participant) to be set with sound source information in response to a user instruction.

After step S230, the controller 30 executes acquisition (S231) of sound source information.

To be more specific, the controller 30 acquires the sound source information to be set to the sound source selected in step S230 in response to the user's instruction. As an example, the controller 30 acquires the sound source name information of the selected sound source. Further, the controller 30 may acquire icon information, recognized language information, translation language information, or a combination thereof for the selected sound source. The controller 30 may display an input form (e.g., a text field, a menu, a radio button, a check box, or a combination thereof) on the display 11 of the display device 10 to obtain the sound source information. The controller 30 may acquire participant information of the conversation and generate an element of an input form (a menu, a radio button, or a check box) based on the participant information. The participant information of the conversation may be manually set before the start of the conversation, or may be acquired from account names logged in the information processing system 1 or the conference system in cooperation.

After step S231, the controller 30 executes the update (S232) of the sound source information.

To be more specific, the controller 30 updates the sound source information by registering the sound source information acquired in step S231 in the sound source database (FIG. 5) in association with the sound source IDs for identifying the sound sources selected in step S230.

The controller 30 may end the sound source setting process shown in FIG. 10 after step S232. Alternatively, the controller 30 may repeatedly execute the sound source setting process until the user instructs the end of the sound source setting process or the sound source information is set to all the unregistered participants.

### (5) Summary

As described above, the controller 30 of the present embodiment acquires the estimation result indicating the direction of the sound source with respect to the multi-microphone device 50, and acquires the information regarding the content of the speech which is emitted from the sound source and collected by the multi-microphone device 50. The controller 30 generates a map image in which the text is arranged at a position corresponding to the direction of the sound source corresponding to the text with respect to the multi-microphone device 50, and displays the map image on the display 11 of the display device 10. Thus, the viewer of the map image can intuitively recognize the association between the sound source (for example, a speaker) and the content of the sound (for example, speech) emitted from the sound source.

The controller 30 may identify each sound source existing around the multi-microphone device 50 based on the estimation result of the direction of the sound source, and may set the sound source information regarding the identified sound source, for example, according to a user instruction. Thus, the sound source information can be appropriately set for the sound source corresponding to the text displayed in the map image. The controller 30 may set at least one of the sound source name information, the recognition language information, and the translation language information for the identified sound source. This makes it possible to clarify who made the speech of the text displayed in the map image, and to generate accurate text or text that is easy for the user to understand.

The controller 30 may generate the map image so that the map image includes a microphone icon representing the multi-microphone device 50 and a sound source icon representing the sound source, and the sound source icon is arranged at a position corresponding to the direction of the sound source corresponding to the sound source icon with respect to the multi-microphone device on the circumference around the microphone icon. Thus, the viewer of the map image can intuitively recognize which direction the sound source located with respect to the multi-microphone device 50 emits the sound corresponding to the text displayed on the map image. Further, the viewer of the map image can intuitively recognize which sound source in the real space corresponds to the sound source icon displayed on the map image. Further, the controller 30 may display the map image so as to emphasize the sound source icon representing the sound source or the information regarding the content of the speech while the sound source is emitting the sound. Thus, even when a plurality of sound source icons and a plurality of texts are displayed on the map image, the viewer can easily distinguish the sound source and the text (for example, the speaker who is making a speech and the speech content) to be noted. Further, the controller 30 may rotate the display positions of the sound source icons and the texts around the display position of the microphone icon so that a specific sound source icon is positioned in a specific direction (for example, downward direction) on the map image. Thus, the speaker (for example, a person with hearing loss) corresponding to the specific sound source icon can easily grasp the correspondence between the other speakers (sound sources) and the sound source icons in the map image.

### (6) Modifications

Modifications of the present embodiment will be described.

### (6-1) Modification 1

A Modification 1 will be described. The Modification 1 is an example of generating minutes in addition to a map image.

### (6-1-1) One Aspect of Modification 1

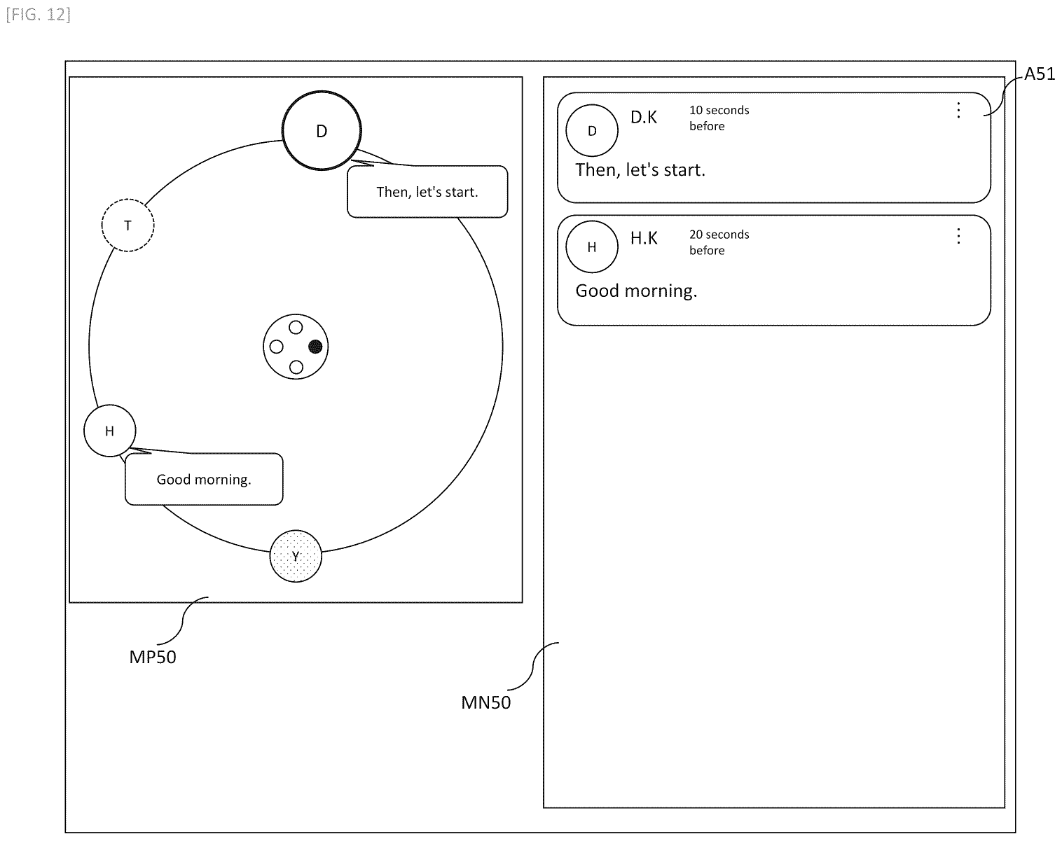

One aspect of the Modification 1 will be described. FIG. 12 is a diagram illustrating an aspect of the Modification 1.

The controller 30 generates a map image and minutes and displays them on the display 11 of the display device 10 while the plurality of participants are having a conversation. The minutes correspond to a speech history in which speech contents by sound sources (speakers) around the multi-microphone device 50 are arranged in time series. The controller 30 updates the map image and the minutes in response to the speech of the participant. Thus, the minutes play a role of a UI for visually grasping the flow of conversation (particularly who has spoken what) in real time.

To be more specific, as shown in FIG. 12, the controller 30 displays the map image MP50 and the minutes (image) MN50 on the display 11 of the display device 10, for example, side by side on one screen. The minutes MN50 includes a display object A51. Instead of arranging the map image MP50 and the minutes MN50 on one screen, the controller 30 may display only one of the map image MP50 and the minutes MN50 selected by the user on the display 11 of the display device 10.

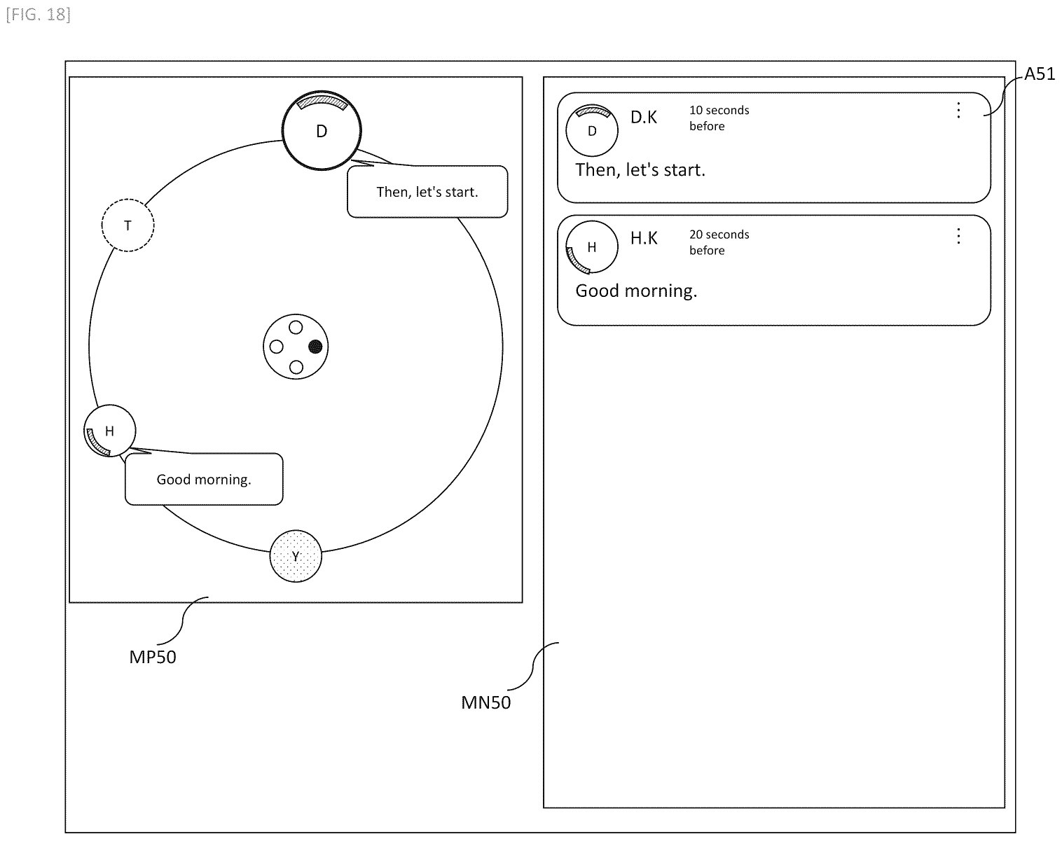

The display object A51 displays information on the speech of the speaker (for example, an icon or a name of the speaker (sound source), a speech time, speech content, or a combination thereof). When a user (for example, a speaker, but may be another user) of the information process system 1 finds an error (for example, an error in speech recognition or an error in machine translation) in the arranged speech content in the minutes MN50, the user can select the display object A51 for displaying the speech content and edit the speech content. The controller 30 acquires the edited speech content from the user via, for example, the input form, and updates the display object A51 based on the speech content. Further, when the map image MP50 includes a text corresponding to the post-edit speech content, the controller 30 may update the text. The controller 30 may cause the display 11 to display a screen shown in FIG. 18 instead of the screen shown in FIG. 12. In the example of FIG. 18, the direction of the speaker with respect to the multi-microphone device 50 is represented by displaying a mark on an arc on the icon of the speaker. Thus, the user can grasp in which direction the speaker of each speech exists with respect to the multi-microphone device 50 only by checking the minutes MP50 without checking the map image MN50.

In this way the controller 30 generates minutes corresponding to the history of the contents of speeches made by speakers around the multi-microphone device 50, and displays the minutes on the display 11 of the display device 10. This allows the viewer of the minutes to easily review the flow of the conversation.

### (6-1-2) Database

A database of a Modification 1 will be described. The following database is stored in the storage unit 31.

### (6-1-2-1) Speech Database

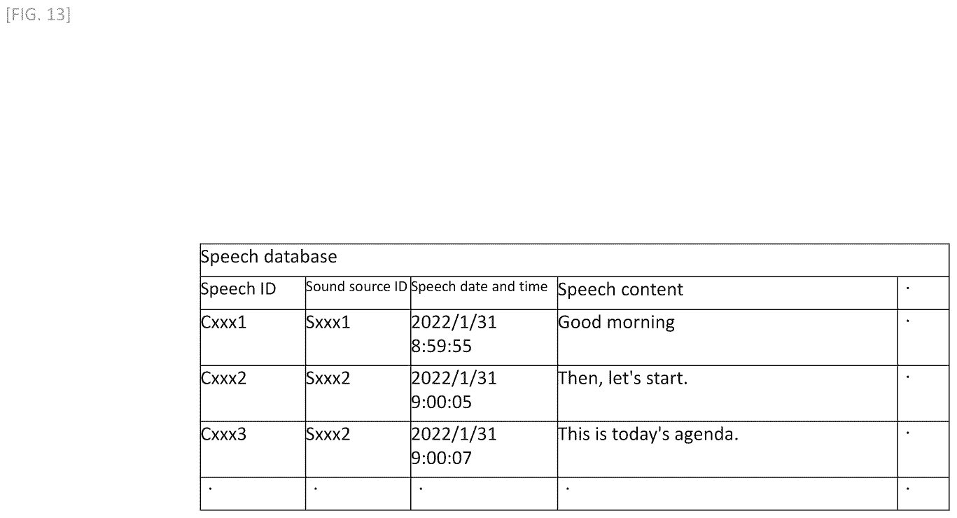

A speech database of a Modification 1 will be described. FIG. 13 is a diagram illustrating data structure of the speech database according to the Modification 1.

The speech database stores speech information. The speech information is information regarding a speech (utterance) collected by the multi-microphone device 50.

As illustrated in FIG. 13, the speech database includes a “speech ID” field, a “sound source ID” field, a “speech date and time” field, and a “speech content” field.

Each field is associated with each other.

The “speech ID” field stores a speech ID. The speech ID is information for identifying a speech. When the controller 30 detects a new speech from the speech recognition result or the machine translation result, the controller 30 issues a new speech ID and assigns the speech ID to the speech. The controller 30 divides the speech according to the change of the speaker. The controller 30 can also divide a series of speeches made by the same speaker in accordance with a boundary in terms of speech (for example, a silent section) or a boundary in terms of the meaning of text.

The “sound source ID” field stores a sound source ID. The sound source ID is information for identifying a speaker (sound source) who has made a speech. The sound source IDs correspond to foreign key for referring to the sound source database of FIG. 5 as a parent table.

In the “speech date and time” field, speech date and time information is stored. The speech date and time information is information about the date and time when the speech was made. The speech date and time information may be information indicating an absolute date and time or information indicating an elapsed time from the start of the conversation.

In the “speech content” field, speech content information is stored. The speech content information is information on the content of the speech. The speech content information is, for example, a speech recognition result for the speech, an machine translation result for the speech recognition result, or an editing result for these by the user.

In the present embodiment, the speech database can also be used to reproduce a map image at a specific time point.

### (6-1-3) Information Processing

Information processing of the Modification 1 will be described.

### (6-1-3-1) Speech Processing

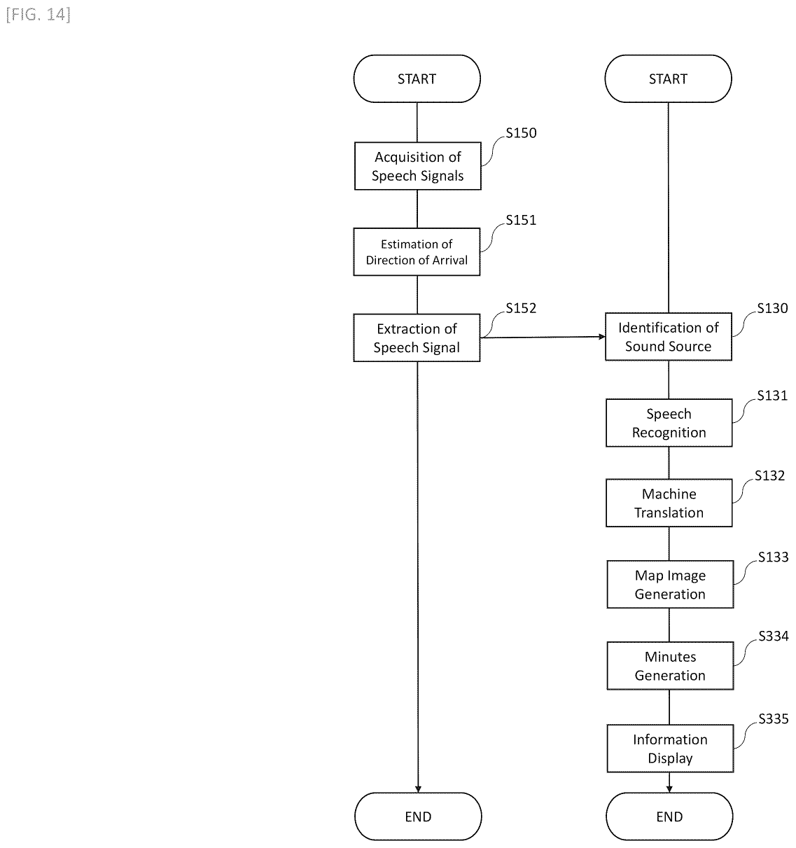

The speech processing of the Modification 1 will be described. FIG. 14 is a flowchart of the speech processing of the Modification 1.

The speech processing shown in FIG. 14 is started after the display device 10, the controller 30, and the multi-microphone device 50 are powered on and the initial settings is completed. However, the start timing of the process illustrated in FIG. 14 is not limited thereto. The process shown in FIG. 14 may be repeatedly executed, for example, at a predetermined cycle, and thus the user of the information processing system 1 can view the map image and the minutes updated in real time.

As shown in FIG. 14, the multi-microphone device 50 performs the acquisition of the speech signal (S150), the estimation of the arrival direction (S151), and the extraction of the speech signal (S152), as in FIG. 6.

After step S152, the controller 30 executes the identification of the sound source (S130), the speech recognition processing (S131), the machine translation (S132), and the generation of the map image (S133), as in FIG. 6. The controller 30 registers the speech information in the speech database (FIG. 13) between step S130 and step S132.

After step S133, the controller 30 executes minutes generation (S334).

Specifically, the controller 30 refers to the speech database (FIG. 13) and generates minutes. As an example, the controller 30 may update the minutes generated at the time of execution of the previous step S334 (hereinafter referred to as “previous minutes”) based on the speech information registered in the speech database between step S130 and step S132 (that is, new speech information).

After step S334, the controller 30 executes information display (S335).

To be more specific, the controller 30 displays the map image generated in step S133 and the minutes generated in step S334 on the display 11 of the display device 10.

### (6-1-4) Summary

As described above, the controller 30 of the Modification 1 generates minutes based on text (that is, a speech recognition result or a machine translation result) regarding speech by a sound source (speaker) existing around the multi-microphone device 50, and displays the minutes on the display 11 of the display device 10 side by side with the map image. Thus, the viewer of the map image and the minutes can intuitively recognize the association between the speaker and the content of the speech by the speaker by browsing the map image, and can easily review the flow of the conversation by browsing the minutes. The controller 30 may generate minutes by arranging texts related to the utterances in chronological order of the date and time of the utterances. Thus, the viewer of the minutes can intuitively recognize the flow of the conversation so far. The controller 30 may edit the arranged text in the minutes in accordance with a user instruction. Thus, even when a user (particularly, a person with hearing loss) misunderstands the speech content due to an error in speech recognition or machine translation, the user who has made the speech or a nearby user can quickly correct the error, and thus smooth communication can be promoted. In addition, it is possible to leave an accurate minutes for confirming the contents of the speeches during the conference after the conference is over.

### (6-2) Modification 2

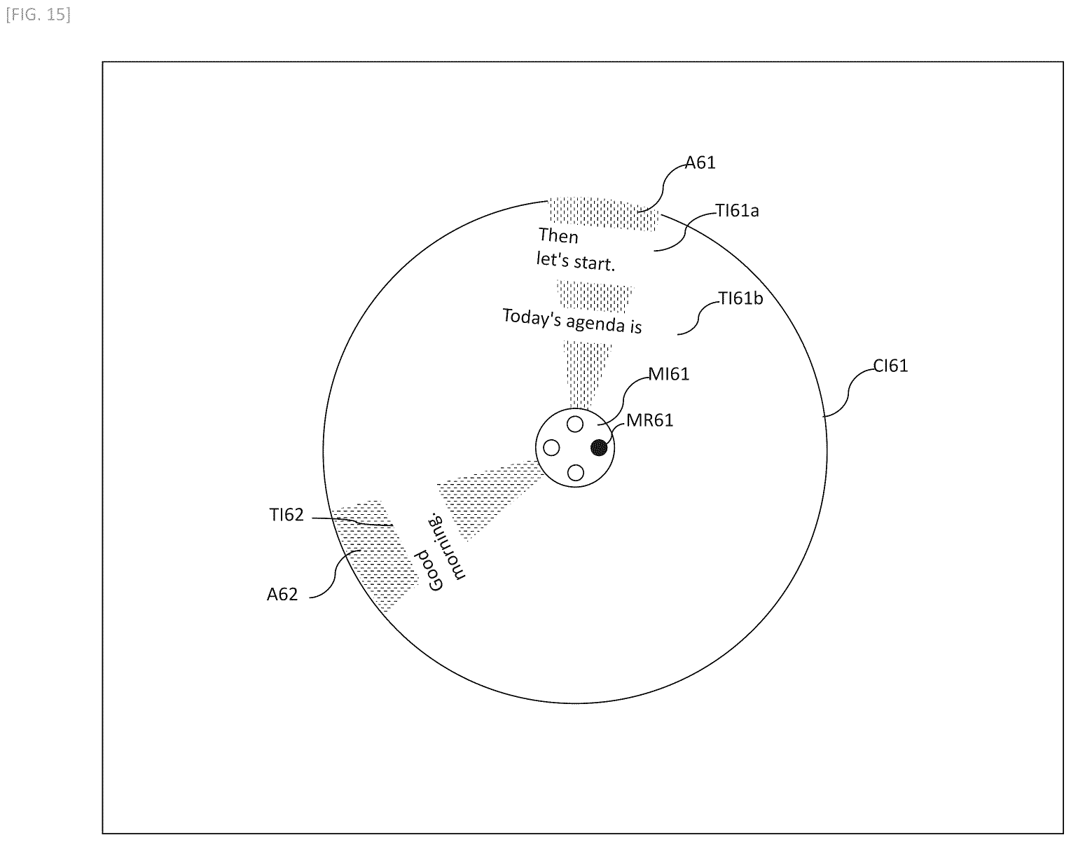

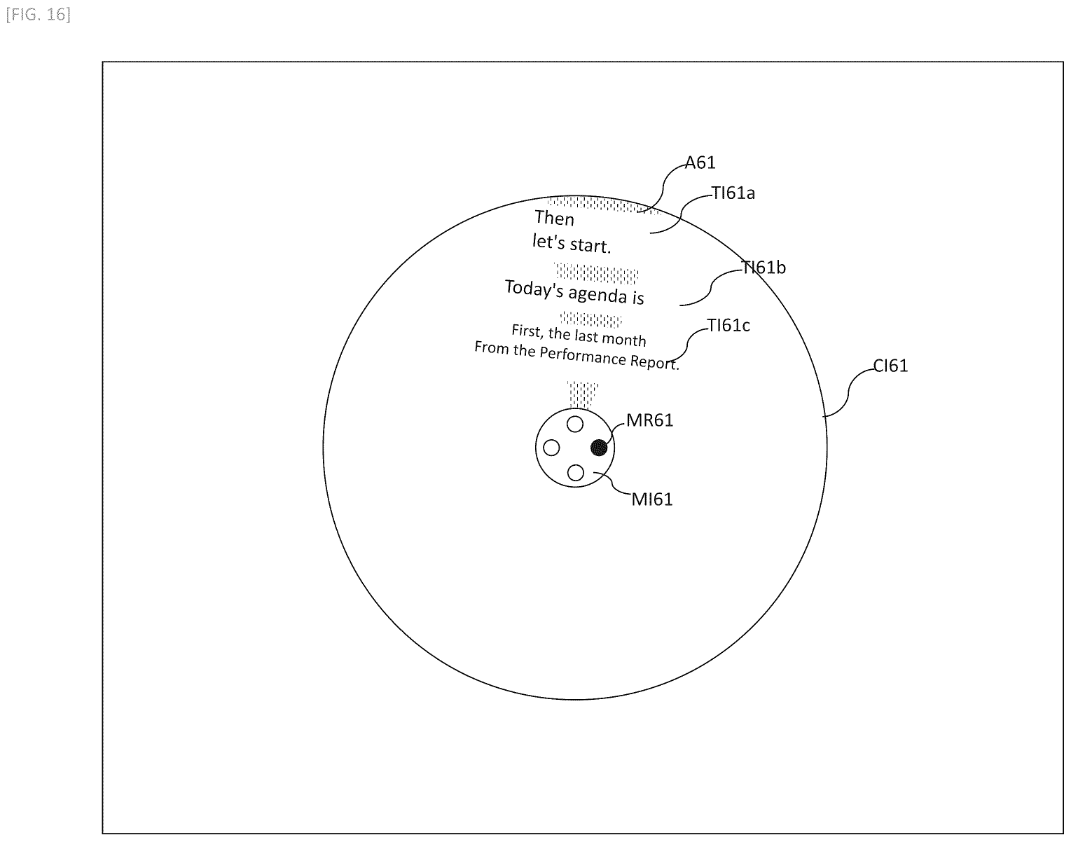

A Modification 2 will be described. The Modification 2 is an example of generating a map image different from that of the present embodiment. FIG. 15 is a diagram illustrating an example of a map image according to the Modification 2. FIG. 16 is a diagram illustrating another example of the map image of the Modification 2.

The controller 30 generates a map image and displays the map image on the display 11 of the display device 10 while the plurality of participants are having a conversation. The map image corresponds to a view of a sound source (speaker) environment around the multi-microphone device 50, and a text based on a speech uttered from the speaker is arranged at a position based on the direction of the speaker with respect to the multi-microphone device 50. The controller 30 updates the map image in accordance with the speech of the participant. Thus, the map image serves as a UI for visually grasping the contents of the latest conversation (particularly, who is talking what) in real time.

To be more specific, the map image shown in FIG. 15 includes a microphone icon MI61, a circumference CI61, display objects A61 and A62, and text images TI61a, TI61b, and TI62.

The microphone icons MI61 represent the multi-microphone devices 50, similarly to the microphone icons MI31 (FIG. 4). The microphone icon MI61 includes a mark MI61 indicating the direction of the microphone icon MR61.

The circumference CI61 corresponds to a circumference around the microphone icon CI31, similarly to the circumference MI61 (FIG. 4).

The text image TI61a corresponds to content of a speech by the first speaker, and the speech has the second latest speech date and time among the text images TI61a, TI61b, and TI62 displayed in FIG. 15. The text image TI61a is arranged at a position corresponding to the direction of the first speaker with respect to the multi-microphone device 50. To be more specific, the text image TI61a is arranged along a straight line extending from the display position of the microphone icon MI61 (an example of “origin of map coordinate system”) to the (estimated) direction of the first speaker.

The text image TI61b corresponds to content of a speech by the first speaker, and the speech has the latest speech date and time among the text images TI61a, TI61b, and TI62 displayed in FIG. 15. The text image TI61b is arranged at a position corresponding to the direction of the first speaker with respect to the multi-microphone device 50. To be more specific, the text image TI61b is arranged along a straight line extending from the display position of the microphone icon MI61 to the (estimated) direction of the first speaker. However, the text image TI61b is arranged at a position closer to the display position of the microphone icon MI61 than the text image TI61a corresponding to the older speech date and time.

The display object A61 displays the (estimated) direction of the first speaker (sound source) with respect to the multi-microphone device 50. The display object A61 corresponds to a fan shape having a predetermined angular range with a straight line extending from the display position of the microphone icon MI61 toward the first speaker as a center. The controller 30 may set a specific format different from that of an object that displays the direction of another speaker in the display object A61. The controller 30 may set the display object A61 to at least partially the same format as the text images TI61a and TI61b. For example, the controller 30 may make the display object A61 have a color similar to the background or characters of the text images TI61a and TI61b.

The text image TI62 corresponds to content of a speech by the second speaker, and the speech has the oldest speech date and time among the text images TI61a, TI61b, and TI62 displayed in FIG. 15. The text image TI62 is arranged at a position corresponding to the direction of the second speaker with respect to the multi-microphone device 50. To be more specific, the text image TI62 is arranged along a straight line extending from the display position of the microphone icon MI61 to the (estimated) direction of the second speaker.

The display object A62 displays the (estimated) direction of the second speaker (sound source) with respect to the multi-microphone device 50. The display object A62 corresponds to a fan shape having a predetermined angular range with a straight line extending from the display position of the microphone icon MI61 toward the second speaker as the center. The controller 30 may set a specific format different from that of an object that displays the direction of another speaker in the display object A62. The controller 30 may set the display object A62 to at least partially the same format as the text image TI62. For example, the controller 30 may make the display object A62 have a color similar to the background or characters of the text image TI62.

The controller 30 updates the map image shown in FIG. 15 to the map image shown in FIG. 16 in response to a new speech by the participant.

To be specific, the map image illustrated in FIG. 16 includes a microphone icon MI61, a circumference CI61, a display object A61, and text images TI61a, TI61b, and TI61c.

The text image TI61a corresponds to the content of the speech by the first speaker, and the speech has the oldest speech date and time among the text images TI61a, TI61b, and TI61c displayed in FIG. 16. The text image TI61a is arranged along a straight line extending from the display position of the microphone icon MI61 in the (estimated) direction of the first speaker, as in FIG. 15. However, the controller 30 moves the display position of the text image TI61a in a direction away from the display position of the microphone icon M61, as compared with the map image shown in FIG. 15.

The text image TI61b corresponds to the content of the speech by the first speaker, and the speech has the second latest speech date and time among the text images TI61a, TI61b, and TI61c displayed in FIG. 16. The text image TI61b is arranged along a straight line extending from the display position of the microphone icon MI61 in the (estimated) direction of the first speaker, as in FIG. 15. However, the controller 30 moves the display position of the text image TI61b in a direction away from the display position of the microphone icon M61, as compared with the map image shown in FIG. 15. Accordingly, the text image TI61b is arranged at a position closer to the display position of the microphone icon MI61 than the text image TI61a corresponding to the older speech date and time and at a position farther from the display position of the microphone icon MI61 than the text image TI61c corresponding to the newer speech date and time.

The text image TI61c corresponds to content of a speech by the first speaker, and the speech has the latest speech date and time among the text images TI61a, TI61b, and TI61c displayed in FIG. 16. The text image TI61c is arranged along a straight line extending from the display position of the microphone icon MI61 in the (estimated) direction of the first speaker. However, the text image TI61c is arranged at a position closer to the display position of the microphone icon MI61 than the text images TI61a and TI61b corresponding to the older speech date and time.

In the example of FIG. 16, the controller 30 does not arrange the text image TI62 corresponding to the utterance position older than the text image TI61a on the map image, and does not arrange the display object A62 on the map image. This makes it easier for the viewer of the map image to pay attention to the content of the latest speech and the speaker.

In this way, the controller 30 generates a map image by arranging texts corresponding to speeches uttered by the same speaker along the (estimated) direction of the speaker with respect to the multi-microphone devices 50 so that the texts are away from the origin (for example, the display position of the microphone icon MI61) of the map coordinate system in order of the corresponding generation date and time. Thus, the viewer of the map image can intuitively recognize the association between the speaker and the speech content, and can grasp the temporal order of the messages based on the distances between the display positions of the texts corresponding to the messages and the origin of the map coordinate system. In the examples of FIGS. 15 and 16, each text image is displayed in a state of being rotated in a direction corresponding to the direction of the sound source, but the present modification is not limited thereto, and each text image may stand upright regardless of the direction of the sound source.

### (6-3) Modification 3

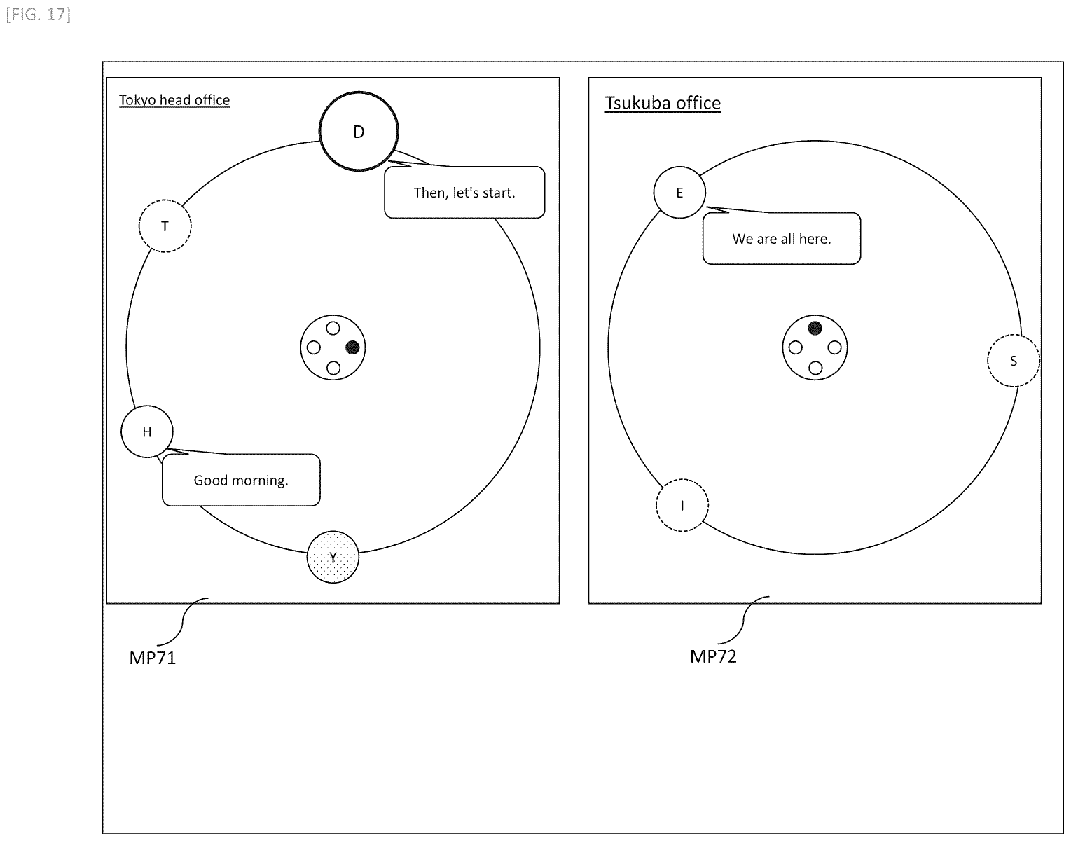

A Modification 3 will be described. The Modification 3 is an example in which a map image is generated for each of a plurality of multi-microphone devices installed at different locations. FIG. 17 is a diagram illustrating an example of a map image according to the Modification 3.

While a conversation is being held by a plurality of participants present in different locations (for example, different conference rooms, different business locations, or different companies), the controller 30 generates a map image for each location and displays the map image on the display 11 of the display device 10. Each map image corresponds to a view of a sound source (speaker) environment around the multi-microphone device 50 installed at each location, and a text based on a speech uttered from the speaker is arranged at a position based on the direction of the speaker with respect to each multi-microphone device 50. The controller 30 updates the map image in accordance with the speech of the participant. Thus, the map image serves as a UI for visually grasping the contents of the most recent conversation at each location (particularly, who is talking what at which location) in real time.

To be more specific, as shown in FIG. 17, the controller 30 displays the map image MP71 of the first location and the map image MP72 of the second location on the display 11 of the display device 10, for example, side by side on one screen. Note that the controller 30 may display only one of the map images MP71 and MP72 selected by the user on the display 11 of the display device 10 instead of arranging the map images MP71 and MP72 on one screen.

In this way, the controller 30 generates a map image for each of the plurality of multi-microphone devices 50 installed at different locations. Thus, for example, even when a plurality of participants at different locations hold a remote conference, the viewer of the map image can intuitively recognize the association between the location, the speaker, and the speech content. In particular, although it is difficult for the participant at the first location to accurately grasp who is making a speech at the second location as compared with the participant at the second location, the participant at the first location can easily specify the speaker at the second location by browsing the map image of the second location. That is, it is possible to compensate for a decrease in the sense of realism due to the remote conference.

### (7) Other Modifications

The storage unit 31 may be connected to the controller 30 via a network.

Each step of the information processing described above can be executed by any of the display device 10, the controller 30, and the multi-microphone device 50. For example, the controller 30 may acquire multichannel speech signals generated by the multi-microphone devices 50, and may estimate the arrival direction (S151) and extract the speech signals (S152).

In the above description, the display device 10 and the controller 30 are independent devices. However, the display device 10 and the controller 30 may be integrated. For example, the display device 10 and the controller 30 can be implemented as one tablet computer or personal computer. The multi-microphone device 50 may be integrated with the display device 10 or the controller 30. Further, for example, the controller 30 may be provided in the cloud server.

In the above description, the display device 10 is an electronic apparatus such as a tablet computer, a personal computer, a smartphone, or a conference display apparatus that can easily share display contents with a plurality of users. However, the display device 10 may be configured to be wearable on a human head. For example, the display device 10 may be a glass type display device, a head mounted display, a wearable display, or a smart glasses. The display device 10 may be an optical see-through glass type display device, but the form of the display device 10 is not limited thereto. For example, the display device 10 may be a video see-through glass type display device. That is, the display device 10 may include a camera. The display device 10 may display a composite image obtained by combining the text image generated based on the speech recognition and the captured image captured by the camera on the display 11. The captured image is an image obtained by capturing an image of the front direction of the user, and may include an image of a speaker. The display device 10 may be a smartphone, a personal computer, or a tablet computer, for example, and may perform augmented reality display by combining a text image generated based on speech recognition and a captured image captured by a camera.

Further, a plurality of display devices 10 may be connected to one controller 30. In this case, for example, the layout of the map image (for example, the correspondence between the microphone coordinate system and the map coordinate system) and the translation language information may be configured to be changeable for each display device 10.

The display 11 may be implemented in any manner as long as it can present an image to the user. The display 11 can be realized by, for example, the following realizing method:
holographic optical element (HOE) or diffractive optical element (DOE) using an optical element (for example, a light guide plate)
liquid crystal display;
retinal projection display;
LED (Light Emitting Diode) display;
organic EL (Electro Luminescence) Display;
laser display; and
a display that guides light emitted from a light emitter using an optical element (for example, a lens, a mirror, a diffraction grating, liquid crystal, a MEMS mirror, or an HOE).

In particular, when a retinal projection display is used, even a person with weak eyesight can easily observe an image. Therefore, it is possible to make a person who suffers from both hearing loss and amblyopia more easily recognize the arrival direction of the speech sound.

Only a part (for example, an upper half) of the map image may be displayed on the display 11. Thus, even when the display area of the display 11 is small, the visibility of the text image or the like can be maintained. A part of the map image displayed on the display 11 may be switched in response to a user instruction or automatically.

In the above-described embodiment, an example in which a user's instruction is input from the input device of the controller 30 has been described, but the present invention is not limited thereto. A user's instruction may be input from an operation unit included in the display device 10.

In the speech extraction process by the multi-microphone device 50, any method may be used as long as a speech signal corresponding to a specific speaker can be extracted. The multi-microphone device 50 may extract the speech signal by the following method, for example.
Frost beamformer
adaptive filter beamforming (as an example, generalized sidelobe canceller)
speech extraction method other than beam forming (for example, a spatial frequency filter or a machine learning)

In the present embodiment or each of the modifications, an example in which texts (images) regarding speeches made by a plurality of participants are arranged on a map image has been described. The controller 30 may acquire a text posted by a chat participant in a chat associated with a conversation and arrange the text (image) on the map image. Further, the controller 30 may arrange a poster icon representing a chat participant on the map image, similarly to the sound source icon. This makes it easy for the participants of the conversation to recognize the contents of the post made by the chat participants. In this case, the display position of the text posted by the chat participant (hereinafter, referred to as “posted text”) or the poster icon can be determined by various techniques.

As a first example, the controller 30 may display the poster icon or the posted text on the outer side of the circumferential CI31 or the CI61, for example, to distinguish the poster icon or the posted text from the sound source icon or the text related to the speech. As a second example, when the controller 30 detects that the chat participant is the same person as any speaker, the controller 30 may aggregate the speech content and the post content of the same person by displaying the post text of the speaker in the same rule as the text related to the message of the speaker. As a third example, the controller 30 may determine the direction of the chat participant with respect to the multi-microphone devices 50 in response to a user instruction, and may arrange the poster icon or the posted text on the basis of the determined direction (for example, on the circumferential CI31). That is, the controller 30 may move the display position of the poster icon or the posted text in the map image in response to the user instruction. Thus, even when the chat participant does not speak at all and the direction of the chat participant with respect to the multi-microphone device 50 cannot be estimated, the display position of the poster icon or the posted text can be optimized (for example, the poster icon or the posted text can be displayed in the same manner as the sound source icon and the text image of the speaker).

In the Modification 1, the example in which the minutes are generated and the arranged speech contents can be edited in the minutes by the user has been described. The user may add a supplementary explanation about the speech, not limited to the correction of the speech content itself. This can prevent the viewer of the minutes from not being informed of the gist of the speech or being informed of the gist of the speech incorrectly.

In the Modification 1, an example in which minutes in which texts indicating the contents of speeches in a conversation between a plurality of participants are arranged in chronological order is generated has been described. The controller 30 may acquire a text posted by a chat participant in a chat associated with a conversation and generate minutes further based on the text. In this case, the controller 30 generates minutes by arranging the text that has been posted or the text indicating the speech content in chronological order of the posting date and time or the message date and time. For example, the posted text and the text indicating the speech content may be arranged in the same window in chronological order. This makes it easier for the participants of the conversation to recognize the contents of the posts by the chat participants, and also prevents the contents of the posts by the chat participants from being overlooked when the participants review the flow of the discussion.

In the Modification 2, an example in which text images corresponding to three speech contents are arranged on the map image in order from the latest date and time of occurrence has been described. However, the number of text images arranged on the map image may be two or less, or may be four or more. The number of text images arranged on the map image may be fixed or may be variable according to various conditions (for example, the size of the map image and the number of characters included in the speech content). Further, the text image to be arranged on the map image may be determined depending on whether or not the elapsed time from the speech date and time corresponding to the text image is within a threshold value.

The map image described in the present embodiment and the map image described in the Modification 2 can be combined. As an example, in the map image described in the Modification 2, the sound source icon described in the present embodiment may be displayed instead of or in addition to the display objects A61 and A62 indicating the (estimated) direction of the speaker with respect to the multi-microphone devices 50.

In the Modification 3, an example in which map images for two locations are generated has been described. However, the controller 30 may generate map images for three or more locations. Further, the Modifications 1 and 3 may be combined. As an example, the controller 30 may generate minutes by arranging the contents of speeches made by participants at a plurality of locations in chronological order. In this case, the controller 30 may aggregate the speeches of the participants into the same minutes regardless of the locations of the participants.

According to the above disclosure, a user can intuitively associate a speaker with speech content based on visual information.

Although the embodiments of the present invention have been described in detail, the scope of the present invention is not limited to the above-described embodiments. The above-described embodiment can be variously improved and modified without departing from the scope of the present invention. The above-described embodiment and modifications can be combined.

### REFERENCE SIGNS LIST

1: information processing system
10: display device
11: display
30: controller
31: storage unit
32: processor
33: input/output interface
34: communication interface
50: multi-microphone device

1. An information processing apparatus comprising:
at least one processor; and
at least one memory including computer program code, where the at least one memory and the computer program code are configured, with the at least one processor, to cause the apparatus to at least:
acquire information indicating a direction of a sound source with respect to at least one multi-microphone device;
acquire information regarding content of a speech emitted from the sound source and collected by the multi-microphone device;
generate a map image in which information regarding the content of the speech is arranged at a position corresponding to a direction of the sound source of the speech with respect to the multi-microphone device; and
output the map image.

2. The information processing apparatus according to claim 1, wherein the at least one memory and the computer program code are configured, with the at least one processor, to cause the apparatus to:
identify a sound source existing around the multi-microphone device based on the information indicating the direction of the sound source; and
set sound source information regarding the identified sound source in accordance with a user instruction.

3. The information processing apparatus according to claim 2, wherein the at least one memory and the computer program code are configured, with the at least one processor, to cause the apparatus to set at least one of a name of the identified sound source, a language used by the sound source, and a target language of machine translation applied to text regarding content of speech uttered from the sound source.

4. The information processing apparatus according to claim 1, wherein the at least one memory and the computer program code are configured, with the at least one processor, to cause the apparatus to:
generate minutes based on the information regarding the content of the speech; and
output the minutes together with the map image.

5. The information processing apparatus according to claim 4, wherein the at least one memory and the computer program code are configured, with the at least one processor, to cause the apparatus to generate the minutes by arranging the information regarding the content of the speech in chronological order.

6. The information processing apparatus according to claim 4, wherein the at least one memory and the computer program code are configured, with the at least one processor, to cause the apparatus to edit arranged texts in the minutes in accordance with a user instruction.

7. The information processing apparatus according to claim 4, wherein the at least one memory and the computer program code are configured, with the at least one processor, to cause the apparatus to:
acquire a text posted by a chat participant; and
generate the minutes by arranging the text posted by the chat participant and the information regarding the content of the speech.

8. The information processing apparatus according to claim 1, wherein the map image includes a microphone icon representing the multi-microphone device and a sound source icon representing the sound source, and wherein the sound source icon is arranged at a position corresponding to a direction of the sound source corresponding to the sound source icon with respect to the multi-microphone device on a circumference around the microphone icon.

9. The information processing apparatus according to claim 8, wherein
the map image highlights an icon representing the sound source or information about the content of the speech while the sound source is emitting the speech.

10. The information processing apparatus according to claim 8, wherein the at least one memory and the computer program code are configured, with the at least one processor, to cause the apparatus to acquire a text posted by a chat participant, and wherein the map image includes a poster icon representing the chat participant and a text posted by the chat participant.

11. The information processing apparatus according to claim 10, wherein the at least one memory and the computer program code are configured, with the at least one processor, to cause the apparatus to move a display position of the poster icon in the map image in accordance with a user instruction.

12. The information processing apparatus according to claim 8, wherein the map image rotates the display position of the sound source icon and the information regarding the content of the speech around a display position of the microphone icon such that one of the sound source icon is positioned in a predetermined direction on the map image.

13. The information processing apparatus according to claim 1, wherein a plurality of texts regarding speeches uttered from a same sound source are arranged on the map image so as to be away from a center of a coordinate system of the map image in order of older corresponding speech date and time.

14. The information processing apparatus according to claim 1, wherein
the at least one multi-microphone device includes a first multi-microphone device and a second multi-microphone device installed at different locations, and
the at least one memory and the computer program code are configured, with the at least one processor, to cause the apparatus to:
acquire information indicating a direction of a sound source with respect to the first multi-microphone device and information indicating a direction of a sound source with respect to the second multi-microphone device;
acquire a first text regarding a first speech collected by the first multi-microphone device and a second text regarding a second speech collected by the second multi-microphone device;
generate a first map image in which the first text is arranged at a position corresponding to a direction of a sound source of the first speech corresponding to the first text with respect to the first multi-microphone device and a second map image in which the second text is arranged at a position corresponding to a direction of a sound source of the second speech corresponding to the second text with respect to the second multi-microphone device; and
output the first map image and the second map image.

15. A method performed by a computer, comprising:
acquiring information indicating a direction of a sound source with respect to at least one multi-microphone device;
acquiring information regarding content of a speech emitted from the sound source and collected by the multi-microphone device;
generating a map image in which information regarding the content of the speech is arranged at a position corresponding to a direction of the sound source of the speech with respect to the multi-microphone device; and
outputting the map image.

16. A non-transitory computer-readable recording medium that stores a program which causes a computer to execute a method comprising:
acquiring information indicating a direction of a sound source with respect to at least one multi-microphone device;
acquiring information regarding content of a speech emitted from the sound source and collected by the multi-microphone device;
generating a map image in which information regarding the content of the speech is arranged at a position corresponding to a direction of the sound source of the speech with respect to the multi-microphone device; and
outputting the map image.
